(19) United States
(12) Patent Application Publication
(10) Pub. No.: US 2006/0188703 A1
(43) Pub. Date: Aug. 24, 2006

(54) Automated process based on differential settling to obtain density gradients

(75) Inventor: Ravindra S. Upadhye, Pleasanton, CA (US)

Correspondence Address: Michael C. Staggs;Attorney for Applicants, Lawrence Livermore National Laboratory, P.O. Box 808, L-703, Livermore, CA, 94551, US

(73) Assignee: The Regents of the University of California

(21) Appl. No.: 11/064,651

(22) Filed: Feb. 22, 2005

(51) Int. Cl. B32B 7/02

(52) U.S. Cl. 428/212

(57) ABSTRACT

An automated process that can produce targets of any density gradient along an axial and a radial coordinate is explored. Such an approach is based on the observation that particles of different size, shape and density settle in fluid-filled columns differently. The invention presents models and procedures to automate the process so as to obtain any combination of density gradients.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

1. Field of the Invention

The present invention relates in general to a particle differential settling process, and more particularly to a differential settling process that can produce axial and/or radial gradient density objects.

2. Description of Related Art

The gravitational segregation of mixed metallizing and/or brazing powders of different diameters and suspended in a common fluid (e.g., gas or liquid) suspension medium of a specific viscosity have been described by equations showing the relationship of the particle's diameter, its density, and viscosity to the settling velocity and distance. Stokes in 1851 first considered the resistance in which a fluid medium having a predetermined density and viscosity offers to the movement of any spherical powder. His work enables the derivation of equations for the powder's acceleration, velocities, final velocity (also called the terminal velocity), and a “velocity constant”, which characterizes the settling of one or more particles having predetermined sizes and density in a suspension medium.

Background information for materials having impedance gradients is described and claimed in U.S. Pat. No. 4,497,873 entitled “ISENTROPIC COMPRESSIVE WAVE GENERATOR IMPACT PILLOW AND METHOD OF MAKING SAME,” issued Feb. 5, 1985 to Barker, including the following, “The pillows for generating ICE waves in impact experiments are made from the powders of two or more materials with different shock impedances. The powders are blended by sedimentation techniques in a layer on a surface in a manner in which the powder at the bottom portion of the layer is composed primarily of the highest shock impedance material, while powder at the top is composed primarily of the lowest shock impedance material. When placed on a projectile nose piece with the low shock impedance material surface representing the impact surface, the ICE wave will have the desired smoothly-rising profile after a single small initial shock if the transition from low to high shock impedance is smooth through the thickness of the pillow.”

A need exists for improved density gradient materials and methods for making such materials. The present invention is directed to such a need.

### SUMMARY OF THE INVENTION

The present invention is directed to a system for producing variable density objects, which includes: a container having a curved base; a fluid medium having a desired viscosity and density that is disposed within the container; and a mixture of predetermined particles introduced into the top of the container, wherein the introduced particles include different materials having different diameters so as to be arranged by differential settling in said fluid medium to produce an object having a desired axial and a desired radial variable density.

Another aspect of the present invention is directed to a variable density object that includes: a first zone arranged in a curved shape that is arranged by differential settling to produce a predetermined bulk density; and a plurality of subsequent applied zones to the first zone, wherein each of the applied zones is also arranged by differential settling to result in a respective bulk density so that in combination with the first zone, produces an object having a desired axial and a desired radial variable density.

A final aspect of the present invention is directed to a differential settling method for producing a variable density object, comprising: providing a container having a curved base and a predetermined cross sectional area; providing a fluid medium having a predetermined viscosity and density within the container; introducing into the fluid medium, a mixture of desired particles having different diameters and densities, wherein the particles of the mixture settle at predetermined rates to produce a plurality of zonal densities that vary in an axial and a radial direction; removing the object from the fluid medium and the container; and sectioning off predetermined portions of the zonal densities to produce an object having a desired axial and a desired radial variable density.

Accordingly, the present invention provides desired materials with axial and radial density gradients capable of being integrated in a number of physics experiments.

### BRIEF DESCRIPTION OF THE DRAWINGS

FIG. 1 shows a plot of particle size versus settling time of highly dense tungsten particles and lightly dense aluminum particles.

FIGS. 2(a)-(d) illustrate the simultaneous injection method.

FIGS. 3(a)-3(d) illustrate the sequential injection method.

FIGS. 4(a)-(c) illustrates forming axial and radial density gradients.

### DETAILED DESCRIPTION OF THE INVENTION

Referring now to the following detailed information, and to incorporated materials; a detailed description of the invention, including specific embodiments, is presented.

Unless otherwise indicated, numbers expressing quantities of ingredients, constituents, reaction conditions and so forth used in the specification and claims are to be understood as being modified by the term “about.” Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical value, however, inherently contains certain errors necessarily resulting from the standard deviation found in their respective testing measurements.

General Description

The present invention provides objects having axial and radial density gradients with a density range spanning a factor of at least 20. Accordingly, by carefully selecting particles of different densities and different sizes (e.g., diameters of up to about 500 microns) and fluids with desired viscosity and density, desired different terminal velocities can be obtained for the particles while arranged to fall freely in the selected fluids in designed containers so as to produce a layer of deposited particles having a desired bulk density.

Specific Description

Model Development

The terminal velocity vₜ of a spherical particle of diameter dₚ and density ρₚ, having gravitational acceleration g, in a liquid of viscosity μ and density ρ₁ is given by the Stokes Equation:

$${v}_{t} = \frac{g . {d}_{p}^{2} . ( {ρ}_{p} - {ρ}_{l} )}{18 μ} \qquad ( 1 )$$

Conversely, the particle size corresponding to a predetermined terminal velocity vₜ is given by:

$${d}_{p} = \sqrt{\frac{18. μ . {v}_{t}}{g . ( {ρ}_{p} - {ρ}_{l} )}} \qquad ( 2 )$$

For a liquid tower of length L, the time to settle through the tower length is given by

$${t}_{s} = \frac{L}{{v}_{t}} \qquad ( 3 )$$

Given particles of different densities, their diameters and densities can be denoted as d_{d}, •_{d}, and •ₗ, respectively, where the secondary subscripts d and l stand for dense and light. Similarly, their terminal velocities and settling times can be denoted as Vₜ_{_{—}}_{^{d}}, tₛ_{_{—}}_{^{d}}, and tₜ_{_{—}}_{^{l}}, respectively.

The preceding analysis assumes particles of fixed diameters, with sharp distinction between different diameters. A more likely scenario is a distribution of particle sizes. In principle, the concepts developed above are still valid for such a scenario but the ranges of settling times may need to be obtained experimentally by methods known to those skilled in the art.

Moreover, if the thicknesses of the zones are much smaller than the tower length (i.e., zᵢ<<L), the calculations are valid. If this condition is not met, the method of the present invention still works, but the settling times need to be recalculated for each zone (or even within a zone by subdividing it into sub-zones).

In addition, shapes of injected particles are assumed to be spherical. Considering the likely situation of a distribution of shapes among the millions of particles, experiments may be reasonably required to obtain a resultant distribution of terminal velocities and settling times.

Model Example and Results

To illustrate the model as shown above, the following example parameters are assumed:

Light density material (Aluminum with density of 2700 kg/m³);

High density material (Tungsten, with density of 19300 kg/m³);

Liquid: (Methanol, with density of 792 kg/m³ and viscosity of 0.0006 pa·s);

Length of settling tower (i.e., container): 0.25 m.

Table 1 below shows the settling times results for tungsten particles having diameters ranging from about 11 microns to about 1 micron, using equation (1) and equation (3). The last column of Table 1 shows the diameter of the aluminum particle compared to the tungsten particles with respect to settling times based on equation (2). While tungsten and aluminum are utilized to illustrate the principles of the invention as shown in Table 1, other materials, such as, but not limited to, tin, copper, tantalum, gold, platinum, ceramics, and plastics, in addition to aluminum and tungsten, can also be utilized as high and low density materials to produce objects of the present invention as disclosed herein.

TABLE 1
Settling times for tungsten and aluminum particles
EXAMPLE MODEL RESULTS

| | Diameter (microns) of | Diameter (microns) of |
|---|---|---|
| Settling times | High density Tungsten | Light density |
| (ts) min | particle | Aluminum particle |
| 2.0 | 11.0 | 34.3 |
| 2.2 | 10.5 | 32.7 |
| 2.5 | 10.0 | 31.1 |
| 2.7 | 9.5 | 29.6 |
| 3.1 | 9.0 | 28.0 |
| 3.4 | 8.5 | 26.5 |
| 3.9 | 8.0 | 24.9 |
| 4.4 | 7.5 | 23.4 |
| 5.1 | 7.0 | 21.8 |
| 5.9 | 6.5 | 20.2 |
| 8.2 | 6.0 | 18.7 |
| 9.9 | 5.5 | 17.1 |
| 12.2 | 5.0 | 15.6 |
| 15.5 | 4.5 | 14.0 |
| 20.2 | 4.0 | 12.5 |
| 27.5 | 3.5 | 10.9 |
| 39.7 | 3.0 | 9.3 |
| 62.0 | 2.5 | 7.8 |
| 110.2 | 2.0 | 6.2 |
| 247.8 | 1.5 | 4.7 |

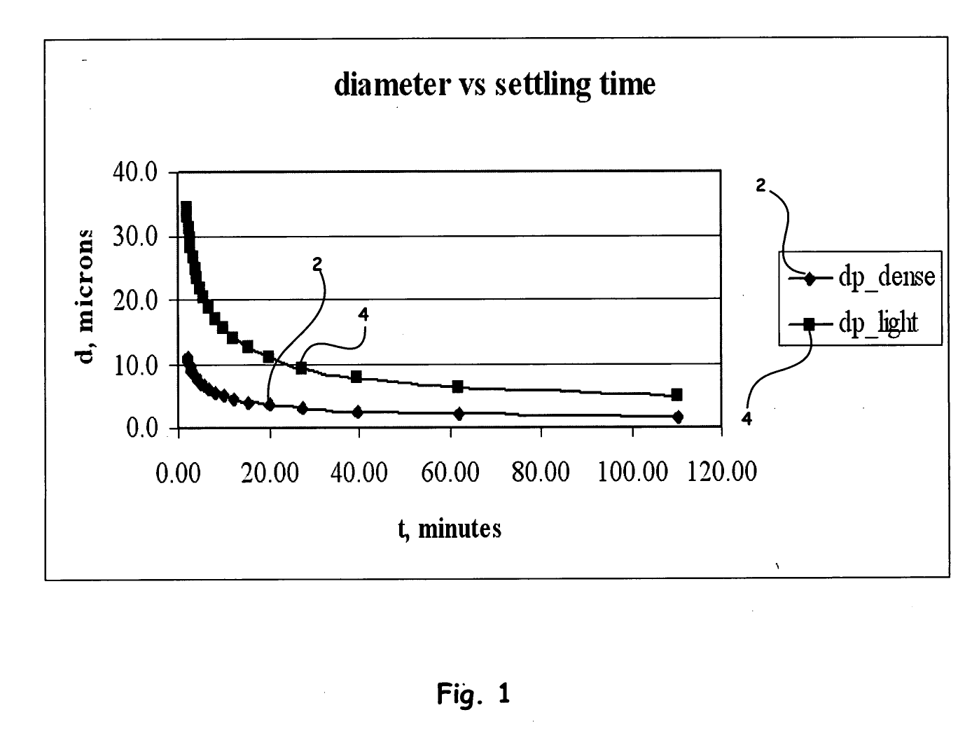

FIG. 1 graphically illustrates particle size versus settling time of the highly dense tungsten particles 2 and the lightly dense aluminum particles 4 as derived from Table 1 having the above assumed parameters.

Creating a Layer with a Specific Density

In the methods of the present invention, dense particles of diameter d_{d} and light particles of diameter dₗ, are selected such that the settling times for the two particles are equal, with mass fractions x_{d} and xₗ (note: x_{d}+xₗ=1). Let the porosity of the mixture be ε. The density ρ of the layer will then be given by:
ρ=(1−ε) (x_{d}·ρ_{d}+x₁·ρ₁) (4)

A layer with such a density as shown in equation (4) can be obtained in two different ways: Simultaneous and Sequential. In the simultaneous mode, the diameters d_{d} and dₗ are selected such that their terminal velocities are the same. If such a mixture of particles having predetermined mass fractions is injected at the top of a liquid tower, such as, for example, a cylinder or a parallelepiped container having a suitable liquid with a desired viscosity and density, such as, for example, isopropyl alcohol or methanol, the particles will settle at the same rate, and the resulting layer will have the density given by equation (4).

In the sequential mode, xₗ kg of the light particles of diameter do, corresponding to a settling time of tₛ_{_{—}}_{^{l}} are placed at the top of the container at time t=0, and x_{d} kg having dense particles of diameter d_{d}, with a settling time of tₛ_{_{—}}_{^{d}} are placed at the top of the container at time t=(tₛ_{_{—}}_{^{l}}−tₛ_{_{—}}_{^{d}}). Such predetermined particle diameters results in both types of particles reaching the bottom of the container at the same time.

Based on these results, two different methods of obtaining axial density gradients can be developed:

Simultaneous Injection

Let there be n zones, starting at the bottom of a container, with n different densities, such that density ρᵢ corresponds to zone i. As one example arrangement, if the restriction is that ρᵢ>ρᵢ₊₁, i.e., the densest zone is at the bottom, the lightest one at the top, the densities can be arranged monotonically from bottom to top. As another example arrangement, the densities can be designed without the restriction to also produce columns in a container with non-monotonic density gradients as discussed infra.

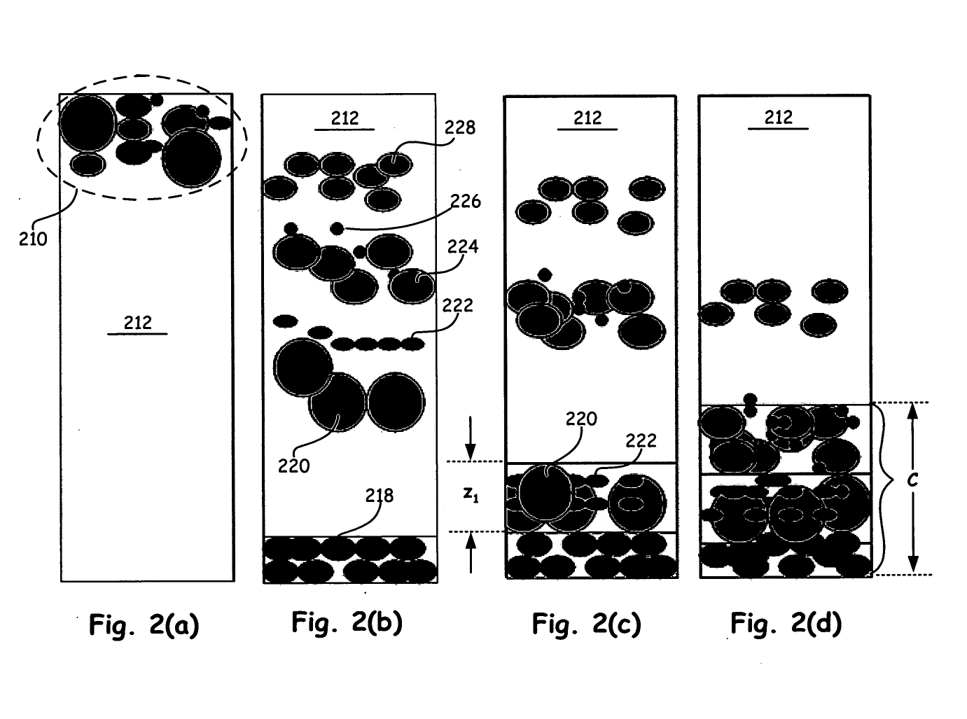

FIG. 2(a)-(d) illustrates the simultaneous injection method to produce a gradient object of the present invention. FIG. 2a shows a mixture 210 (shown within a dashed ellipse) of particles (i.e., particles having different diameters and densities) introduced at the top of a container 212 at time t=0. FIGS. 2(b) and 2(c) show the introduced different particles, 218, 220, 222, 224, 226, 228, corresponding to different zone densities, settling at different rates, such that at the end of the method, a column (denoted by the letter C, as shown in FIG. 2(d)) having a desired axial density gradient can be obtained.

For a predetermined zone, e.g., z₁, as shown in FIG. 2(c), a feasible large dense particle (e.g., 222) can be selected with a corresponding light particle (e.g., 220) having the same settling time. By selecting predetermined proportions of such dense and light particles, a desired density of ρᵢ according to equation (4) can be obtained. By then selecting the total mass W₁ of such a mixture, so that a predetermined zone can have a given length, and by designing container 212, such as, but not limited to, a cylinder container, to have a predetermined cross-sectional area A, then:
W₁=A·z₁·ρ₁ (5)

The above process can then be repeated for a plurality of zones, resulting in a mixture of mass W given by
W=ΣWᵢ (6)

Table 2 below illustrates an example configuration of predetermined zones using the Simultaneous Injection method of the present invention.

| | | Diameters of | Diameters of | | | Settling Times |
|---|---|---|---|---|---|---|
| | Density | Dense particles | Light particles | Mass Fraction | Mass Fraction | (ts) |
| Zone # | (ρ) | (microns) | (microns) | Light particles | Dense particle | (Minutes) |
| 1 | 19.3 | 7.0 | 21.8 | 0.25 | 0.00 | 5.1 |
| 4 | 13.8 | 5.5 | 17.1 | 0.17 | 0.08 | 8.2 |
| 7 | 8.2 | 4.0 | 12.5 | 0.08 | 0.17 | 15.5 |
| 10 | 2.7 | 2.5 | 7.8 | 0.00 | 0.25 | 39.7 |

Sequential Injection

If particles of different sizes are not available, a sequential approach method to obtain the same results can also be utilized in the present invention. For illustration purposes only, assume that the available particle sizes for tungsten and aluminum are 2.5μ and 5.0μ, with settling times of 39.7 and 96.2 minutes, respectively. Table 3 below illustrates how such different mixtures of the same particles can be introduced into a given container to obtain a 10-zone graded density object. The settling times given in the last column are measured from the time of light particle injection, not dense particle injection.

TABLE 3
Example parameters utilizing Sequential Injection Method.

| | | Light particle injection | | | Dense particle injection | | |
|---|---|---|---|---|---|---|---|
| | | Injection | | Settling | Injection | | |
| | | time | Mass | time | time | Mass | Settling time |
| | Density | (Minutes) | Fraction | (Minutes) | (Minutes) | Fraction | (Minutes) |
| Zone # | (ρ) | (t_l) | (x_l) | (ts_l) | (t_d) | (x_d) | (ts_d) |
| 1 | 19.3 | 0.0 | 0.0 | 96.2 | 56.5 | 1.0 | 96.2 |
| 2 | 17.5 | 15.0 | 0.1 | 111.2 | 71.5 | 0.9 | 111.2 |
| 3 | 15.6 | 30.0 | 0.2 | 126.2 | 86.5 | 0.8 | 126.2 |
| 4 | 13.8 | 45.0 | 0.3 | 141.2 | 102 | 0.7 | 141.2 |
| 5 | 11.9 | 60.0 | 0.4 | 156.2 | 117 | 0.6 | 156.2 |
| 6 | 10.1 | 75.0 | 0.6 | 171.2 | 132 | 0.4 | 171.2 |
| 7 | 8.2 | 90.0 | 0.7 | 186.2 | 147 | 0.3 | 186.2 |
| 8 | 6.4 | 105.0 | 0.8 | 201.2 | 162 | 0.2 | 201.2 |
| 9 | 4.5 | 120.0 | 0.9 | 216.2 | 177 | 0.1 | 216.2 |
| 10 | 2.7 | 135.0 | 1.0 | 231.2 | 192 | 0.0 | 231.2 |

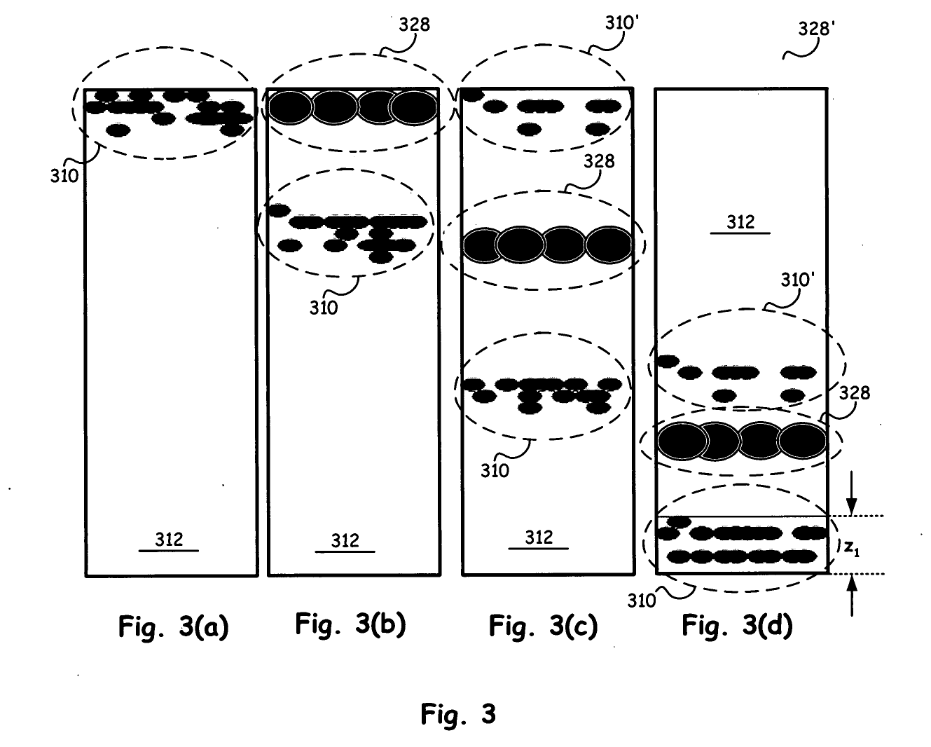

FIG. 3(a)-(d) illustrates the sequential injection method in a container 312 to produce a gradient object of the present invention. FIG. 3a shows particles 310 (shown within a dashed ellipse) all having, for example, a substantially same high density and diameter injected at the top of container 312 to produce as an example, a high density zone z₁, as shown in FIG. 3(d). FIGS. 3(b)-3(c) show subsequent light density particles 328 and high density particles 310′ (i.e., particles of substantially the same density and diameters as particles 310 in FIG. 3(a)), injected at different times (as determined by, for example, Table 3) at the top of container 312. By introducing particles in such a method, a gradient zone (not shown) can be created upon final settling of such particles, as shown in FIG. 3(d).

Obtaining Radial Gradients

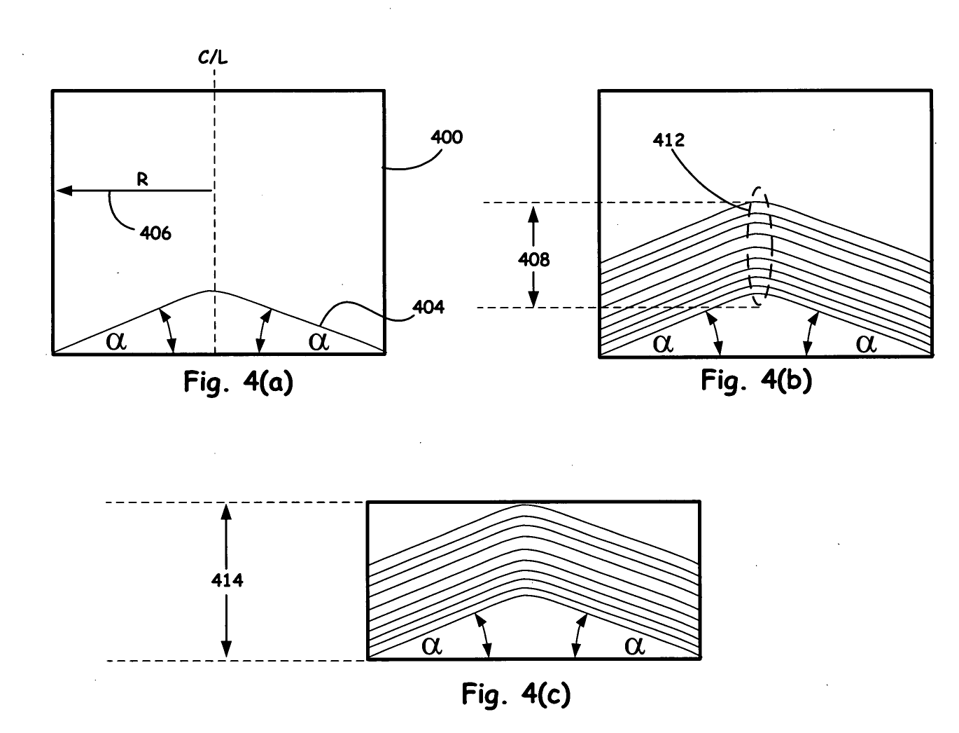

FIG. 4(a)-(c) illustrates an example method embodiment for producing radial gradients. As shown in FIG. 4(a), a tower 400, such as a cylindrical container having a base 404 with a predetermined base angle α of less than about 90 degrees is arranged. For many applications, the required base shape can be curved or have a suitable surface of revolution to obtain a desired variation along a radial gradient 406 (denoted by the letter R) from a center-line position (denoted by C/L and a dashed line). For example, such a shape can be a non-circular curve such as an ellipse or hyperbola with the exact shape highly dependent upon a desired radial gradient.

Next, as shown in FIG. 4(b), a column 408 having an axial gradient 412 (as shown within the dashed ellipse) can be created using either the simultaneous or sequential injection method as discussed above. Finally, as shown in FIG. 4(c), a desired section 414 can be sectioned off by machining or similar techniques known to one skilled in the art so as to have an axial (denoted along the x-axis) and a radial gradient (denoted along the y-axis) density object produced by particle differential settling.

As an additional embodiment, the porosity of the final column 408 (e.g., of the particles) can be fixed in space by use of, for example, plastic binders followed by pyrolysis or burning; sintering, etc.

As another example arrangement, a column with a non-monotonic axial density profile can be produced by the methods of the invention. Such a density profile can be created by dividing column 408, as shown in FIG. 4(b), along the axis into regions inside which the density gradient is monotonic. Then, desired regions having a predetermined density gradients that is non-monotonic can be added utilizing procedures as outlined above for each region.

Changes and modifications in the specifically described embodiments can be carried out without departing from the scope of the invention, which is intended to be limited by the scope of the appended claims.

The invention claimed is:

1. A system for producing variable density objects, comprising:
a container, further comprising: an outer surface having a top edge and a bottom edge; and a base portion having a degree of curvature and cooperating with said bottom edge of said outer surface to form a fluid medium enclosure;
a fluid medium having a desired viscosity and density disposed within said container; and
a mixture of predetermined particles introduced into said fluid medium at said top edge, wherein said particles comprise one or more materials having different shapes, densities and diameters so as to be arranged by differential settling in said fluid medium to produce an object having a desired axial and a desired radial variable density.

2. The system of claim 1, wherein said object comprises a monotonic density gradient along said axial and said radial direction.

3. The system of claim 1, wherein said object comprises a non-monotonic density gradient along said axial and said radial direction.

4. The system of claim 1, wherein said object comprises a non-linear density gradient along said axial and said radial direction.

5. The system of claim 1, wherein said mixture of introduced particles comprises at least two materials selected from tin, copper, tantalum, gold, platinum, aluminum, tungsten, ceramics, and plastics.

6. The system of claim 1, wherein said fluid medium comprises methanol or ethanol.

7. The system of claim 1, wherein introduced particles comprises sequential injection.

8. The system of claim 1, wherein introduced particles comprises simultaneous injection.

9. The system of claim 1, wherein said outer surface of said container comprises a curved shape.

10. A variable density object, comprising:
a first zone arranged in a curved shape, said first zone further comprising a mixture of predetermined particles of different densities and diameters that is arranged by differential settling to produce a predetermined bulk density; and
a plurality of subsequent applied zones to said first zone, each said applied zone further comprising a mixture of predetermined particles of different shapes, densities and diameters that is arranged by differential settling to result in a respective bulk density, wherein in combination with said first zone produces an object having a desired axial and a desired radial variable density.

11. The object of claim 10, wherein said produced object comprises a monotonic density gradient along said axial and said radial direction.

12. The object of claim 10, wherein said produced object comprises a non-monotonic density gradient along said axial and said radial direction.

13. The object of claim 10, wherein said produced object comprises a non-linear density gradient along said axial and said radial direction.

14. The object of claim 10, wherein said mixture of predetermined particles in said first and subsequent zones comprises at least two materials selected from tin, copper, tantalum, gold, platinum, aluminum, tungsten, ceramics, and plastics.

15. The object of claim 10, wherein said mixture of predetermined particles in said first and subsequent zones are arranged by sequential injection.

16. The system of claim 10, wherein said mixture of predetermined particles in said first and subsequent zones are arranged by simultaneous injection.

17. A differential settling method for producing a variable density object, comprising:
providing a container having a curved base and a predetermined cross sectional area;
providing a fluid medium having a predetermined viscosity and density within said container;
introducing into said fluid medium, a mixture of desired particles having different shapes, diameters and densities, wherein said particles of said mixture settle at predetermined rates to produce a plurality of zonal densities that vary in an axial and a radial direction;
removing said object from said fluid medium and said container; and
sectioning off predetermined portions of said zonal densities to produce an object having a desired axial and a desired radial variable density.

18. The method of claim 17, wherein said object comprises a monotonic density gradient along said axial and said radial direction.

19. The method of claim 17, wherein said object comprises a non-monotonic density gradient along said axial and said radial direction.

20. The method of claim 17, wherein said object comprises a non-linear density gradient along said axial and said radial direction.

21. The method of claim 17, wherein said introduced particles comprises at least two materials selected from tin, copper, tantalum, gold, platinum, aluminum, tungsten, ceramics, and plastics.

22. The method of claim 17, wherein said fluid medium comprises methanol or ethanol.

23. The method of claim 17, wherein said introducing step comprises simultaneous injection.

24. The method of claim 17, wherein said introducing step comprises sequential injection.

25. The method of claim 17, wherein said outer surface of said container comprises a curved shape.

26. The method of claim 17, wherein a porosity of said object is fixed in space using plastic binders followed by pyrolysis.
